(19) United States
(12) Patent Application Publication
(10) Pub. No.: US 2013/0198120 A1
(43) Pub. Date: Aug. 1, 2013

(54) SYSTEM AND METHOD FOR PROFESSIONAL CONTINUING EDUCATION DERIVED BUSINESS INTELLIGENCE ANALYTICS

(71) Applicant: MedAnalytics, Inc., Park City, UT (US)

(72) Inventor: Daniel P. Vezina, Park City, UT (US)

(73) Assignee: MEDANALYTICS, INC., Park City, UT (US)

(21) Appl. No.: 13/750,231

(22) Filed: Jan. 25, 2013

Related U.S. Application Data
(60) Provisional application No. 61/591,406, filed on Jan. 27, 2012.

(51) Int. Cl. G06N 99/00

(52) U.S. Cl. CPC G06N 99/005
USPC 706/12; 706/46

(57) ABSTRACT

The present disclosure relates to non-linear analytics engine derived business intelligence. More particularly, the present disclosure describes methods and systems that use content associated with a medical professional continuing education event as a data source for a non-linear analytics engine. The content, which relates to the content creation, content delivery, follow-ups, evaluations, attendee interactions, and administrative tasks associated with medical professional continuing education event, is extracted from a learning management system and subsequently transmitted to the non-linear analytics engine to create business intelligence.

### CROSS-REFERENCE TO RELATED APPLICATIONS

The present application claims the benefit under 35 U.S.C. §119(e) of U.S. Provisional Application 61/591,406 filed Jan. 27, 2012, and is hereby incorporated by reference in its entirety into the present application.

### FIELD OF INVENTION

The present disclosure relates to non-linear analytics, and in particular, methods and systems that use a non-linear analytics engine to generate business intelligence relevant to the medical industry.

### BACKGROUND

The medical industry is continuously in search of valuable information that may be used to guide crucial business decisions regarding the research and development and/or sales and marketing of new or existing medical products and services. It is estimated that such decisions directly impact the allocation of more than $100 billion dollars per year of resources within the medical community.

Currently, the medical industry relies on after-the-fact data sources to develop medical business intelligence. For example, typical after-the-fact data sources used to develop medical business intelligence include reports indicating the number of prescriptions previously filled and/or the number of medical devices previously sold per unit of time. While such information is relevant and provides useful history, it has limited use for predicting future trends. Thus, there is a significant need to provide accurate, future trend analysis, based on information acquired before a drug, medical device, and/or a medical service is prescribed, used or selected.

### BRIEF DESCRIPTION OF THE FIGURES

FIG. 1 is a block diagram illustrating an example analytics system for generating medical business intelligence based on unstructured data sources, in accordance with aspects of the present disclosure.

FIG. 2 is a flowchart illustrating an example method for generating business intelligence from unstructured data and data sources in accordance with aspects of the present disclosure.

FIGS. 3A-3T illustrate screen shots, examples, code and pseudo code, and implementation details of an analytics system conforming to aspects of the present disclosure.

FIGS. 3U-3Z illustrate examples, pseudo code, code, and implementation details concerning machine learning of an analytics system.

### DETAILED DESCRIPTION

Aspects of the present disclosure relate to methods and systems for generating predictive business intelligence relevant to specific medical professionals and/or the medical profession as a whole. Using data sources directly derived from the content, delivery, and administrative tasks of one or more professional continuing education events (CE), such as continuing medical education events (CME), business intelligence may be generated by a non-linear analytic engine that may be used to predict the future trends and/or the current state of thinking by key leaders within the medical professional community and medical industry.

In 2010, there were more than 700 accredited CME providers in the US. A CME provider is an organization allowed to validate and provide accreditation for a post-graduate medical education event. The Accredited Council of Continuing Medical Education (ACCME) is the federally regulated accrediting body implementing the policy and procedures related to the CME space. There are an average of 500,000 CME-accredited educational events per year serving the needs of more than 10 million physicians and mid-level medical practitioners.

Accredited CME providers have to follow strict procedures when sponsoring an educational event, ranging from the content creation, validation, delivery and post-event evaluations. The process is currently done in a very disjointed fashion with a mixed of papers, binders and electronic documents. In addition, CME providers are required to create educational events according to the tight rules and regulations of the ACCME. Each CME provider is accredited for a period varying from 1 to 5 years, depending on their level of compliance with the ACCME requirements when they get reviewed periodically. Each educational event also needs to be reported in a standard format to the ACCME. A standardized, automated platform such a CME-specific learning management system may allow CME specific content creation, content delivery and administrative compliance across the 700 accredited CME providers. The platform may be used to capture the data required to generate business intelligence using a non-linear analytic engine.

Moreover, CME activities are critical for physicians and licensed healthcare providers. Medical professionals are required to participate in CMEs to maintain state licensure. More importantly, the CMEs provide a means for physicians and health care providers to preserve current skills, develop new ones, etc. While CME activity may be critical to healthcare, currently most CME programs lack the technological infrastructure to allow physicians and CME providers alike, the ability to manage, optimize, and maximize the information that can be gleaned from each CME activity.

Accordingly, various aspects of the present disclosure relate to systems and methods that analyze unstructured data sources generated by a professional continuing educational event hosted on a learning management system, to produce predictive business intelligence relevant to the medical industry. The analytics system may use a cluster based non-linear analytic engine as its high-level architecture backbone. The analytics system may be used for data format such as text, rich-text, audio and video feeds. In various aspects, the analytics system may be used for data sources such as courseware prepared within a learning management system, uploaded text documents, slide presentations, student annotations, student text interactions, teacher and students interactions, poll data, follow-up interactions and evaluations within the learning management system. The analytics system may also use data sources such as audio and video feeds of the content delivery or relevant to the content delivery.

According to other aspects, the analytics system may use data sources such as system event data and system user data. The analytics system may use such data for analysis by assigning the data a value and location within clusters of datasets based on algorithms defined by a content expert. The analytics system may analyze the data according to pre-defined rules, new rules or machine learning generated rules. The analytics system may analyze the data within a specific cluster location or across many cluster locations. The analytics system may export or display the results of the analysis by generating reports, ad-hoc analysis reports and advanced analytics. The content of analyses and subsequently generated reports may be industry specific business intelligence.

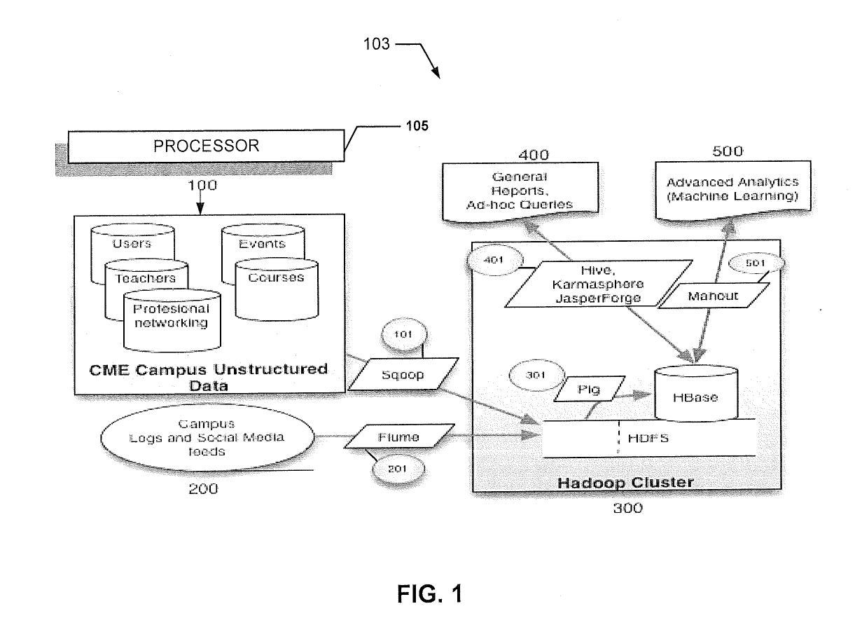

FIG. 1, illustrates and example analytics system 103 for extracting unstructured data from various data sources to generate business intelligence. According to one aspect, the analytics system 103 may be a cloud-based system and/or computing environment. Cloud computing is a type of computing in which dynamically scalable and typically virtualized resources are provided as services via the Internet. As a result, users need not, and typically do not, possess knowledge of, expertise in, or control over the technology and/or infrastructure implemented in the cloud. Accordingly, various aspects and functionalities of the analytics system 103 may be provided and/or accessed through a cloud computing environment. It is also contemplated that the analytics system 103 may be implemented in computing environments other than cloud-based environments.

The analytics system 103 may include at least one processor 105 capable of executing one or more systems, sub-systems, software infrastructures, applications comprising instructions or modules, and/or components etc., located within the analytics system 103 to generate business intelligence based on unstructured data. A software component is a software package, web service, application, or module that encapsulates a set of related functions or data. Software infrastructures include computer software, applications (e.g. operating systems, middleware, virtual machines, etc.), instructions, modules and/or code that interface applications with low-level hardware devices and/or other software applications; provide communication mechanisms for cooperation among the devices and applications; and manage resources between the devices and/or applications. For example, in one embodiment, the analytics system 103 may include a learning management system 100 that is specific to a particular professional continuing education and capable of capturing unstructured data. The analytics system 103 may also include a data feed of unstructured data generated social media sources and other publicly available data sources 200 (“outside sources”); a data warehouse and clustered analytic ecosystem 300 (“analytic ecosystem”); an output of business intelligence reports and ad-hoc reports 400; and another output of business intelligence such as advanced analytics 500; all of which may be executable by the processor 105. Moreover, while each of the various components are depicted as individual systems, infrastructures, components and/or applications, it is contemplated that all of such individual systems, infrastructures, components and/or applications of the of the analytics system 103 may be combined in various ways, including being combined into a single or multiple software applications.

The analytics system 103 may accomplish data ingestion 101 and 201 such as parsing and loading. Unstructured data from the learning management system 100 is extracted and written to the Hadoop distribution file system located inside the analytic ecosystem 300. The data flow 101 may be supported by Sqoop, a component in the Hadoop distribution file system, designed for extracting data from relational databases and importing the data into the file system for further processing. In data flow 201, the unstructured data from outside sources 200 is extracted and written to the Hadoop file system located inside the analytic ecosystem 300. The data flow 201 may be supported by Flume, another Hadoop tool designed for ingesting large amounts of distributed data, such as log files, into the file system.

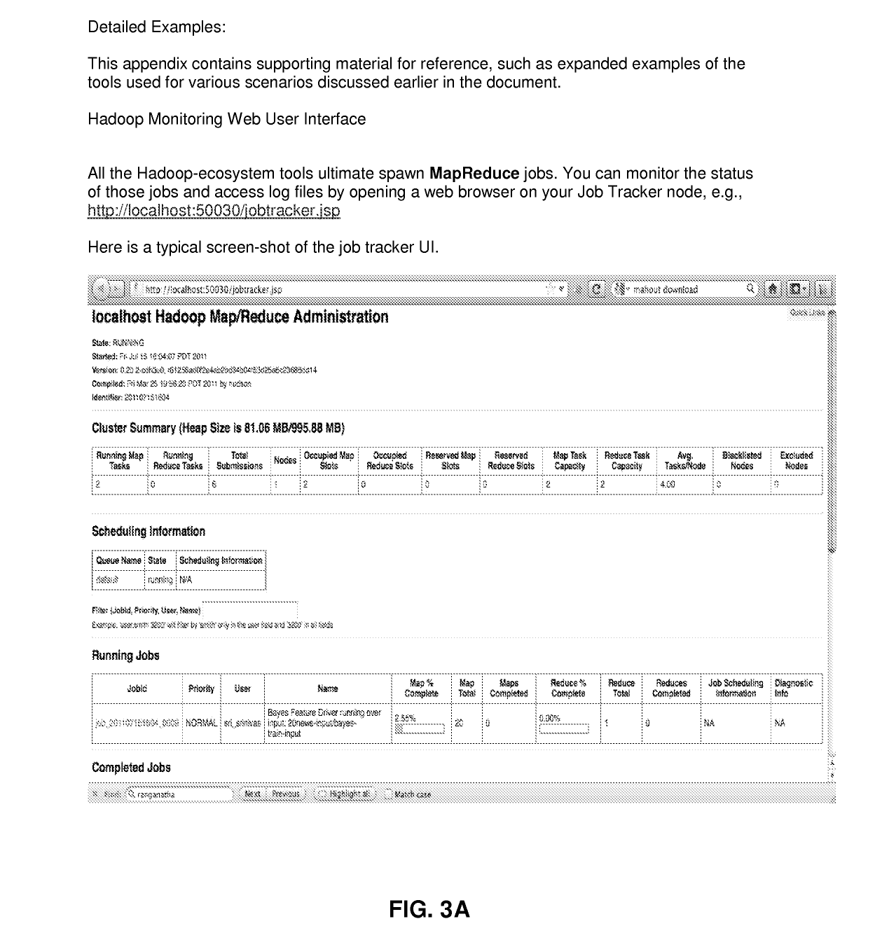

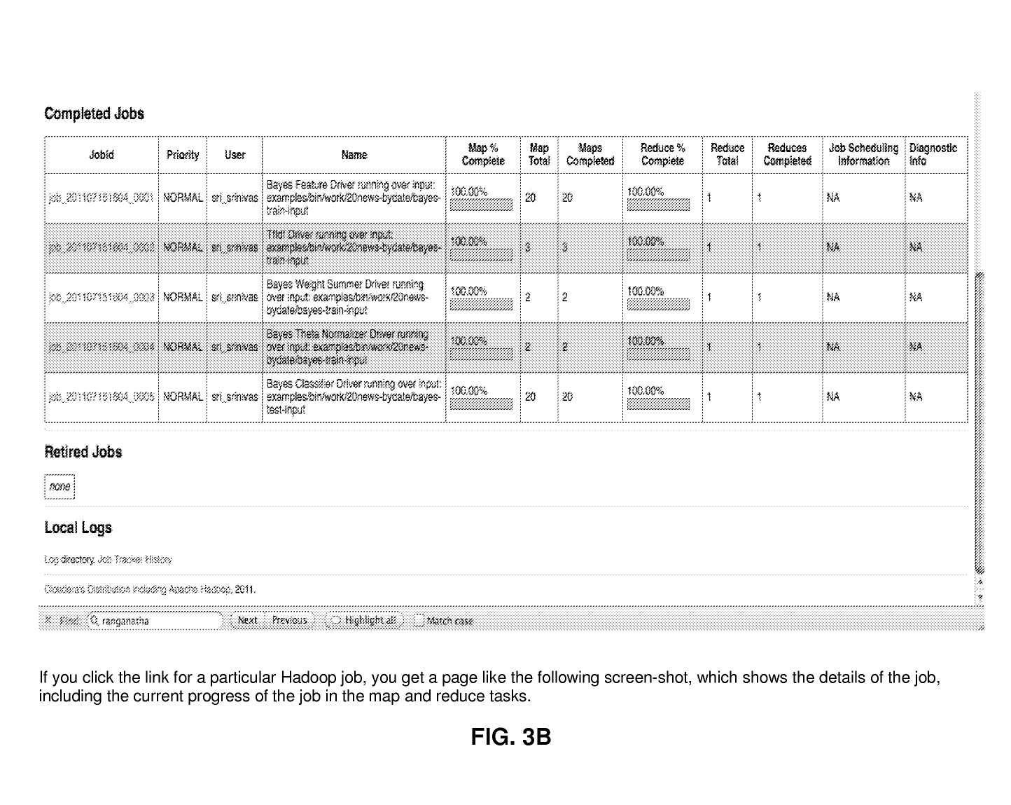

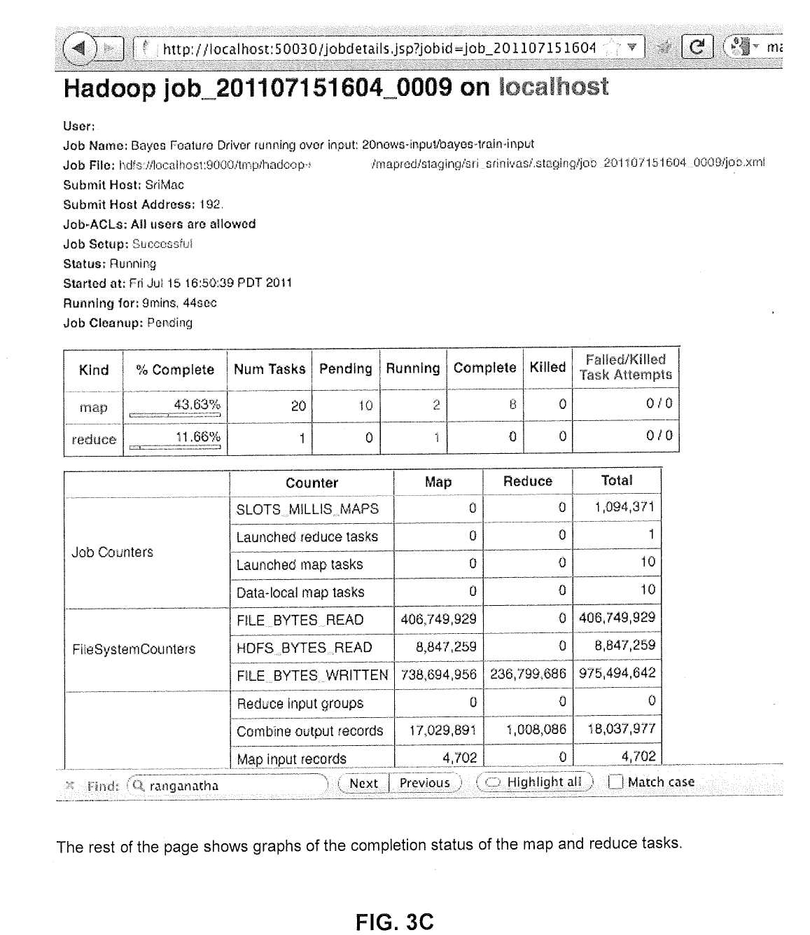

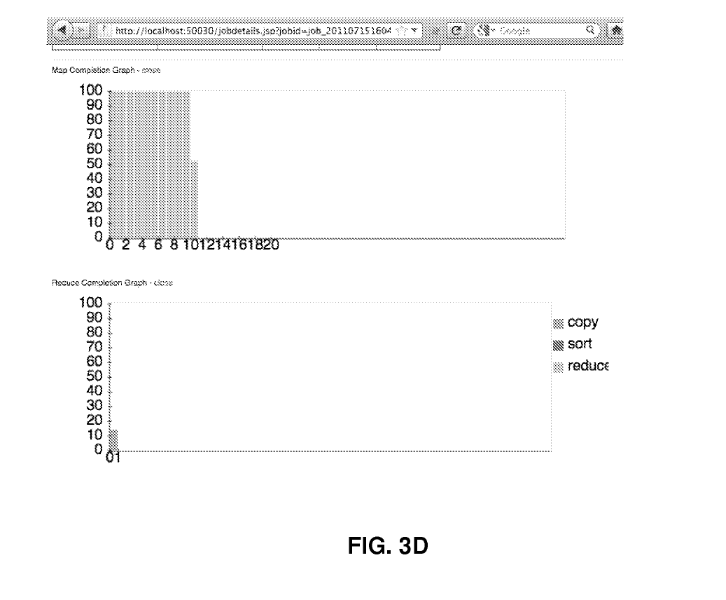

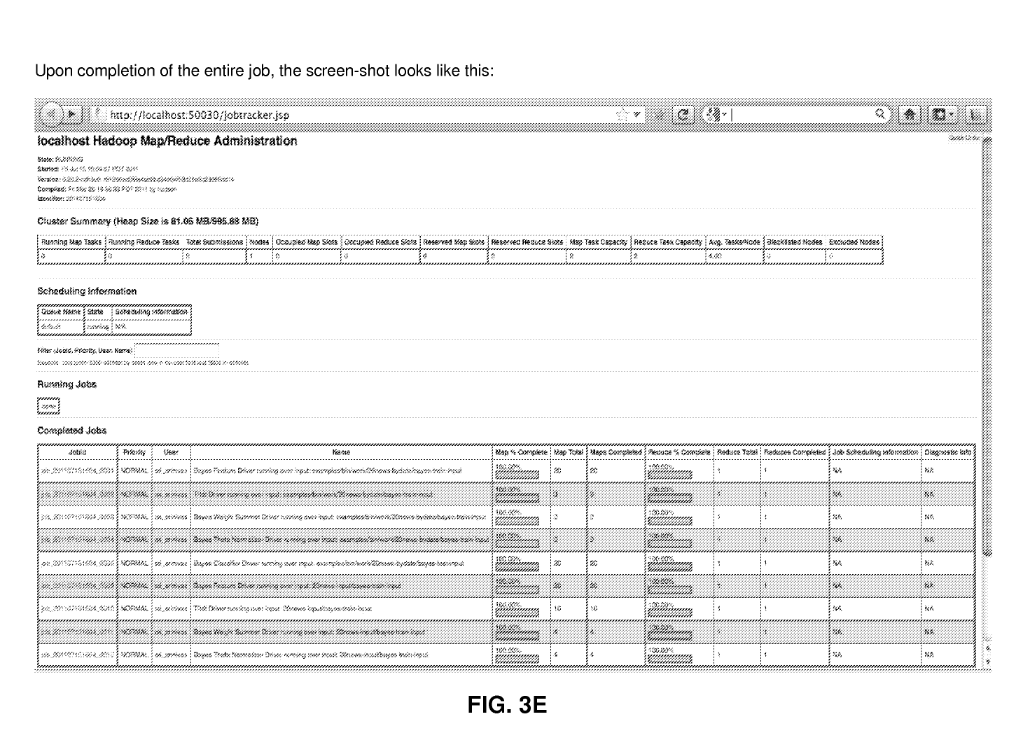

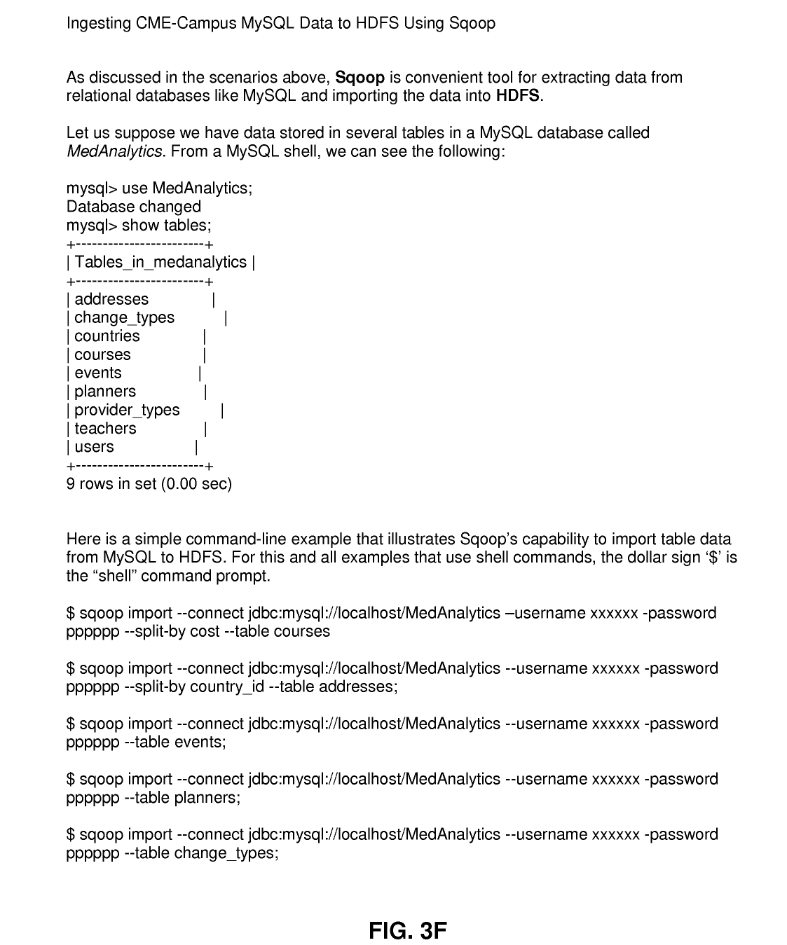

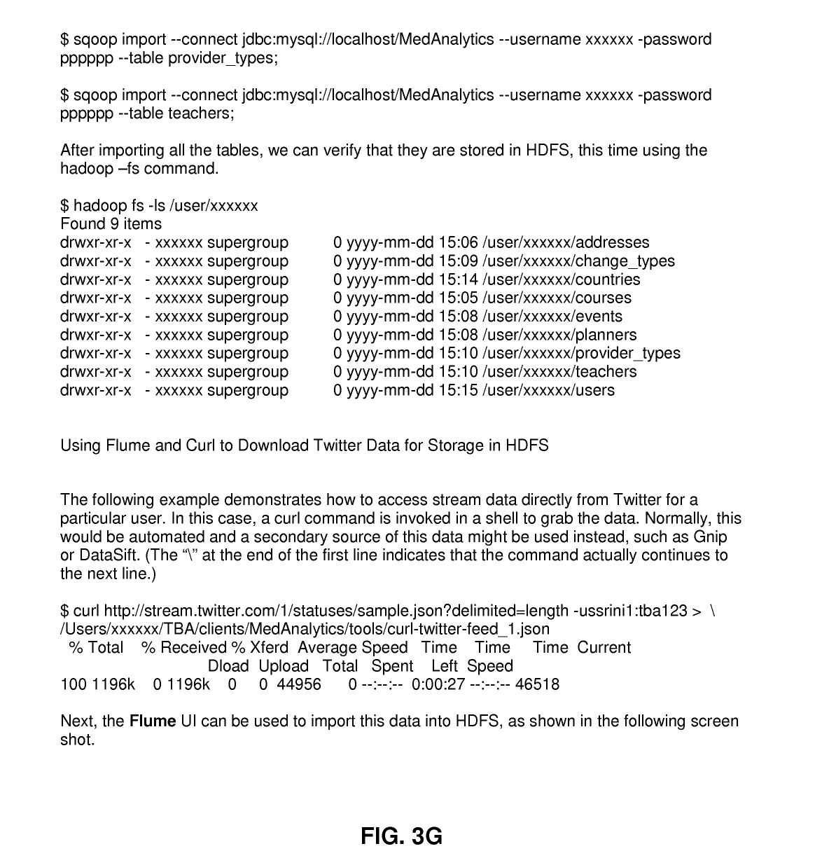

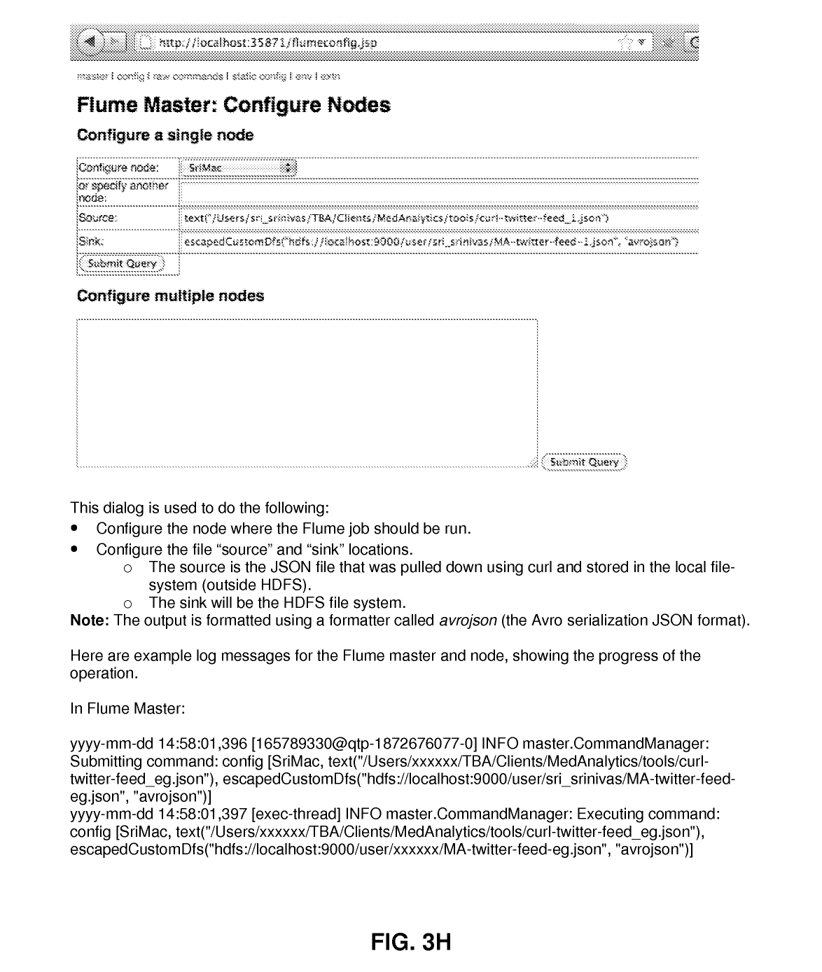

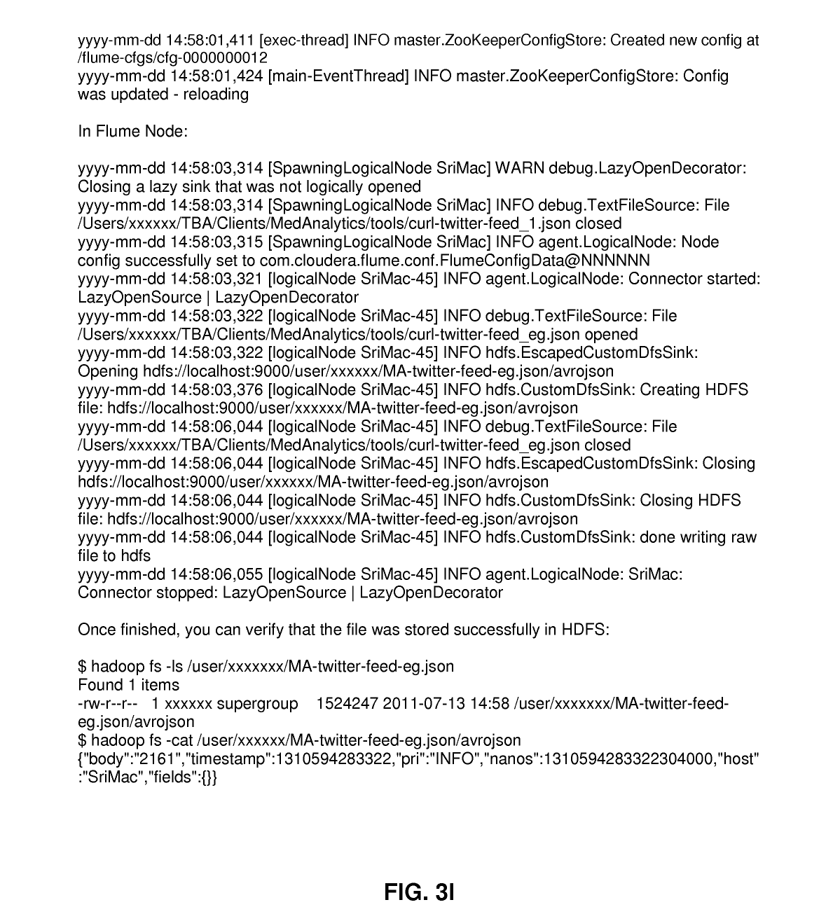

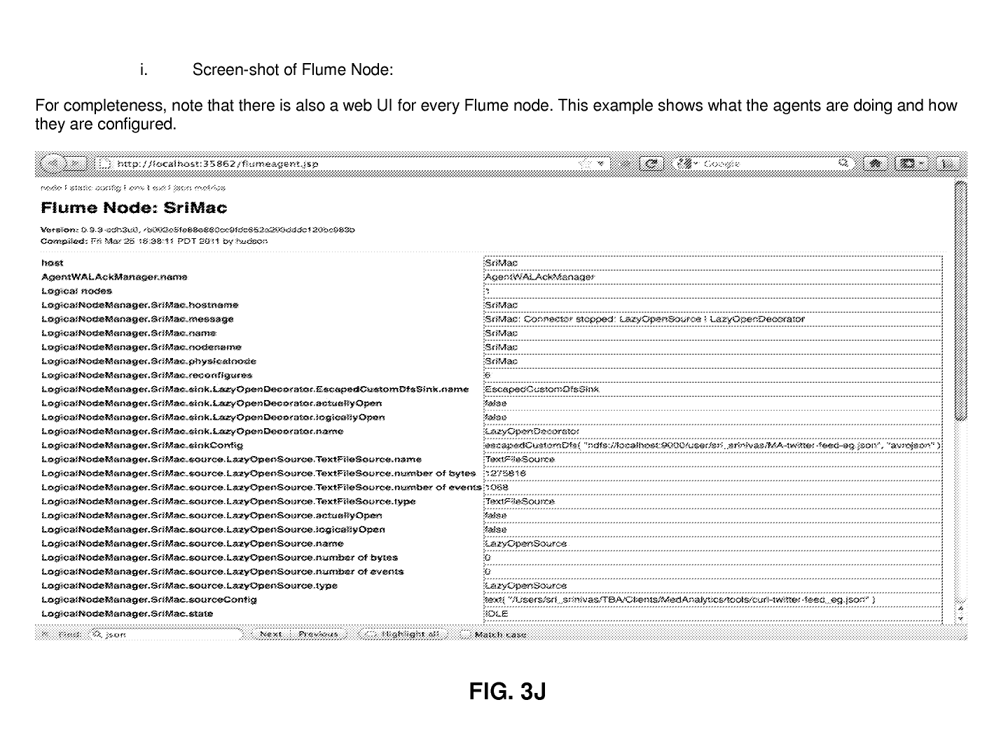

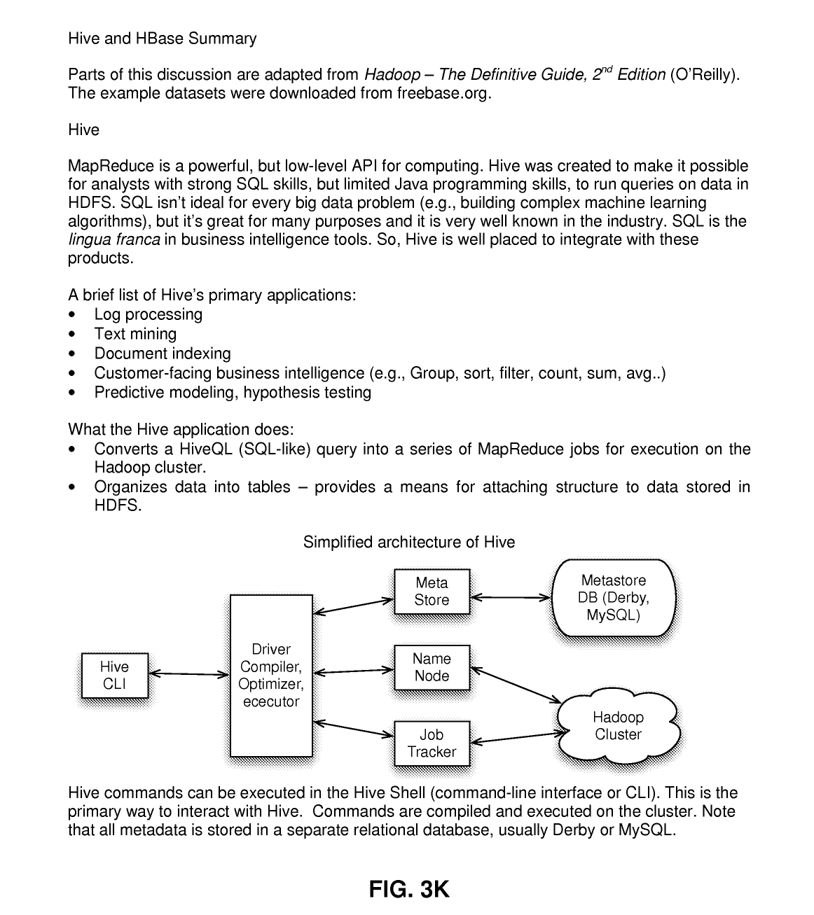

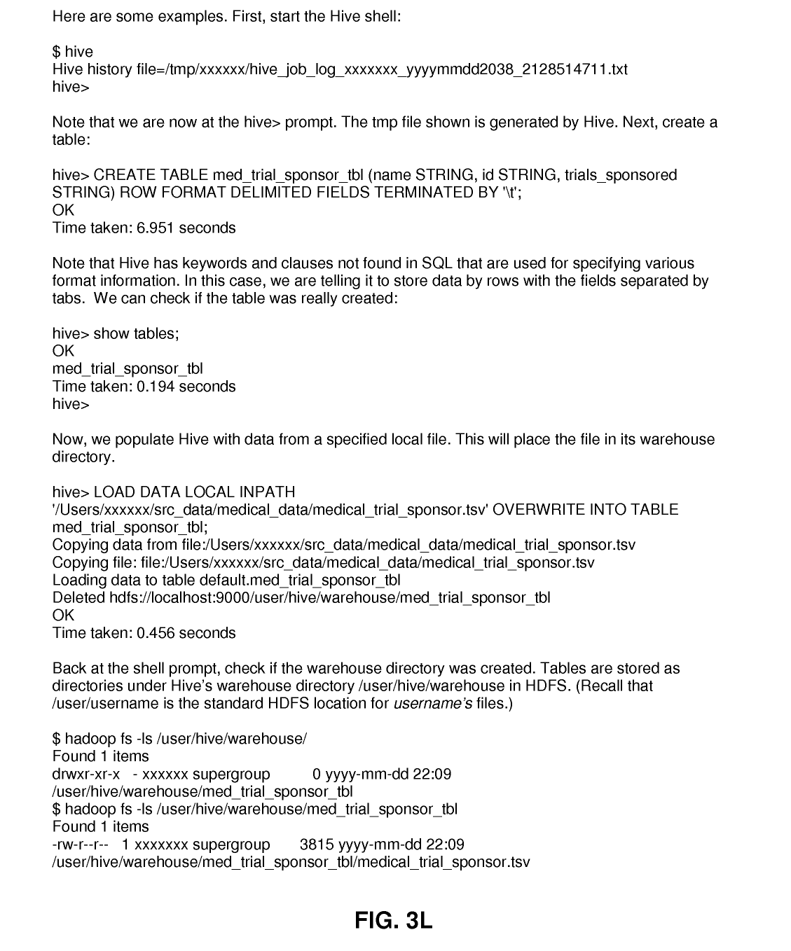

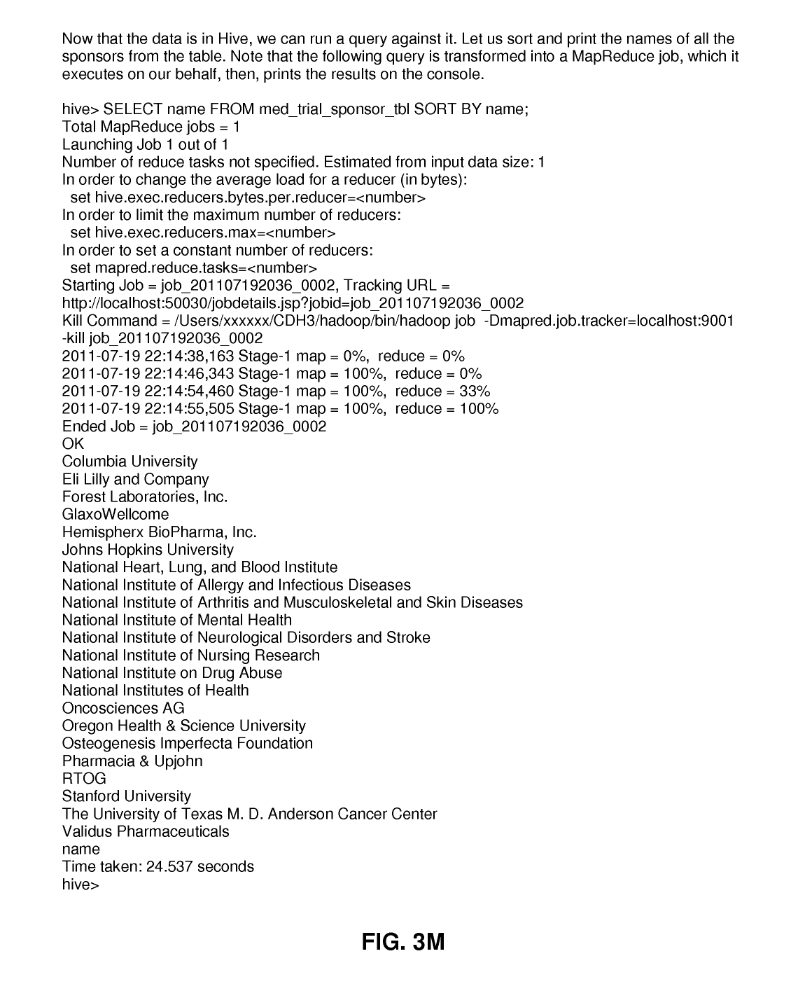

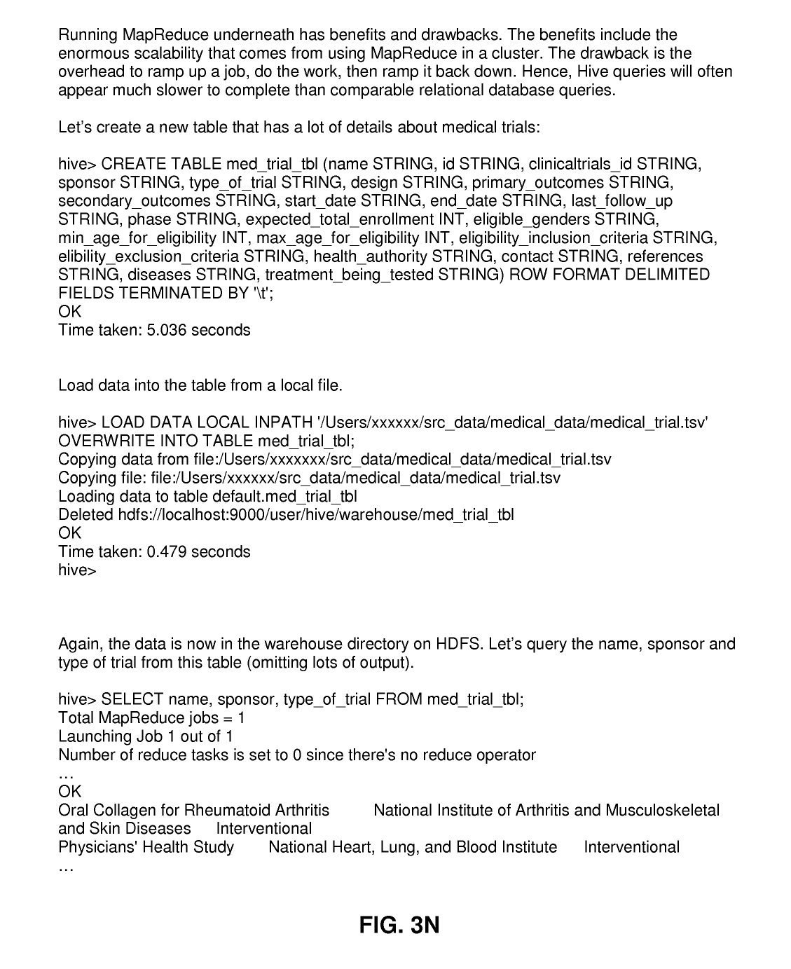

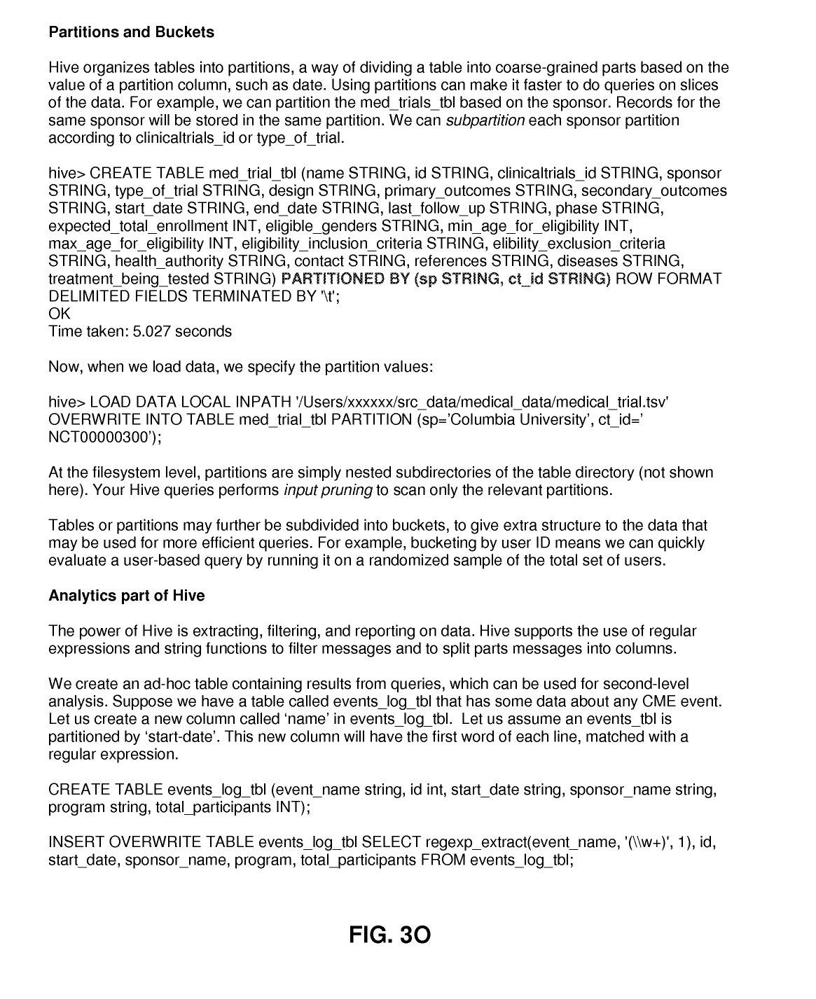

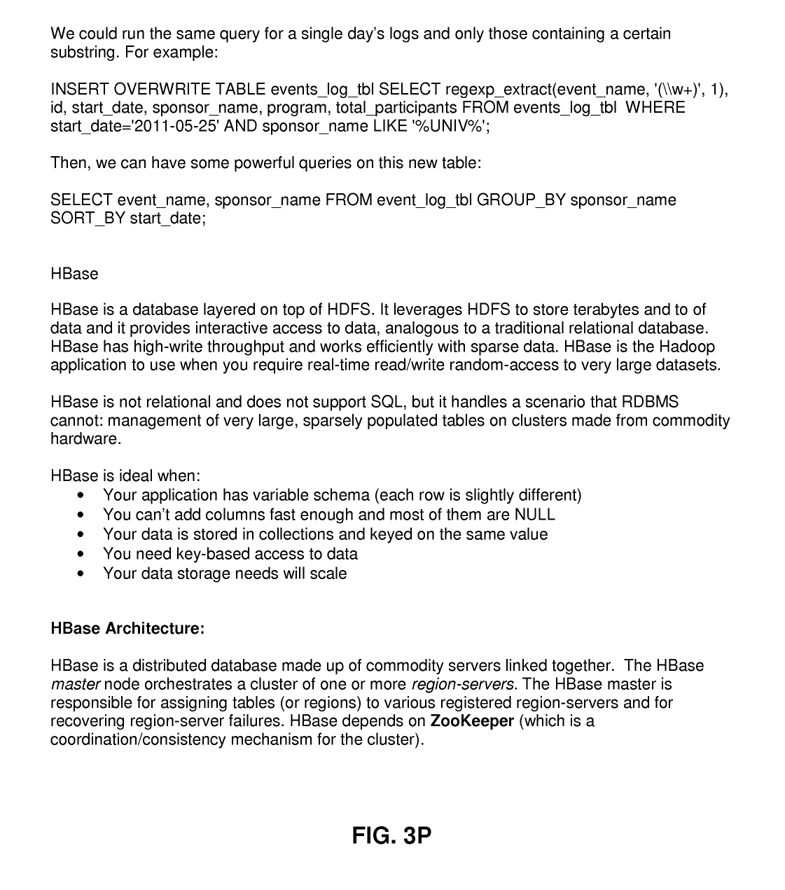

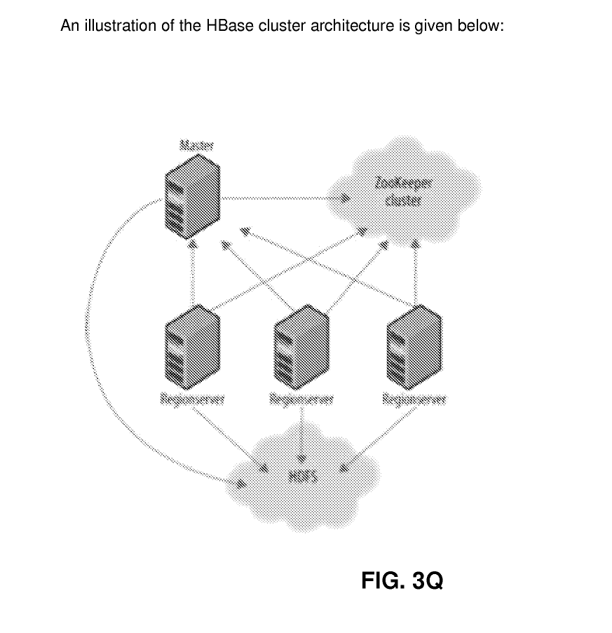

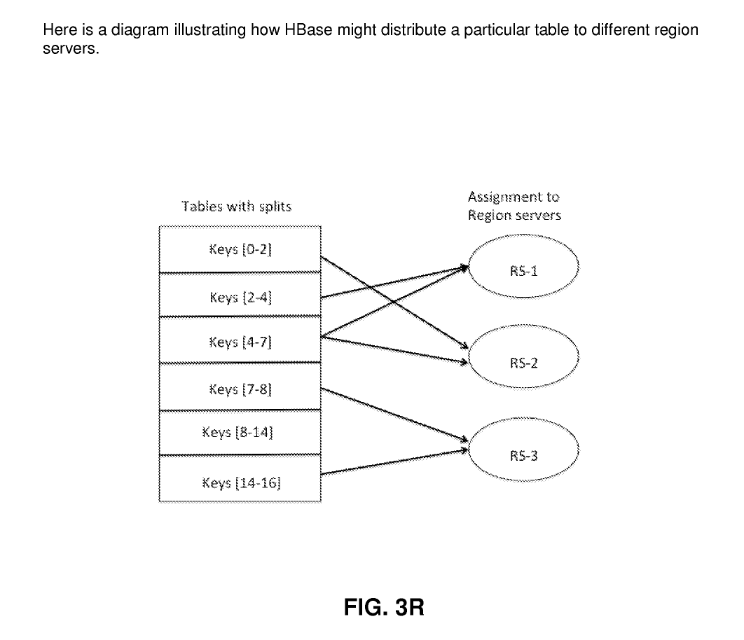

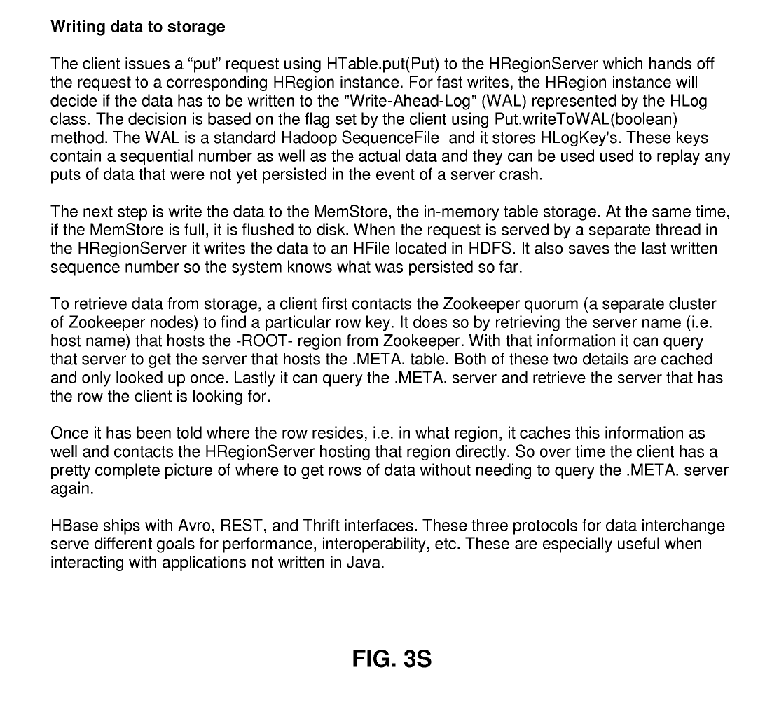

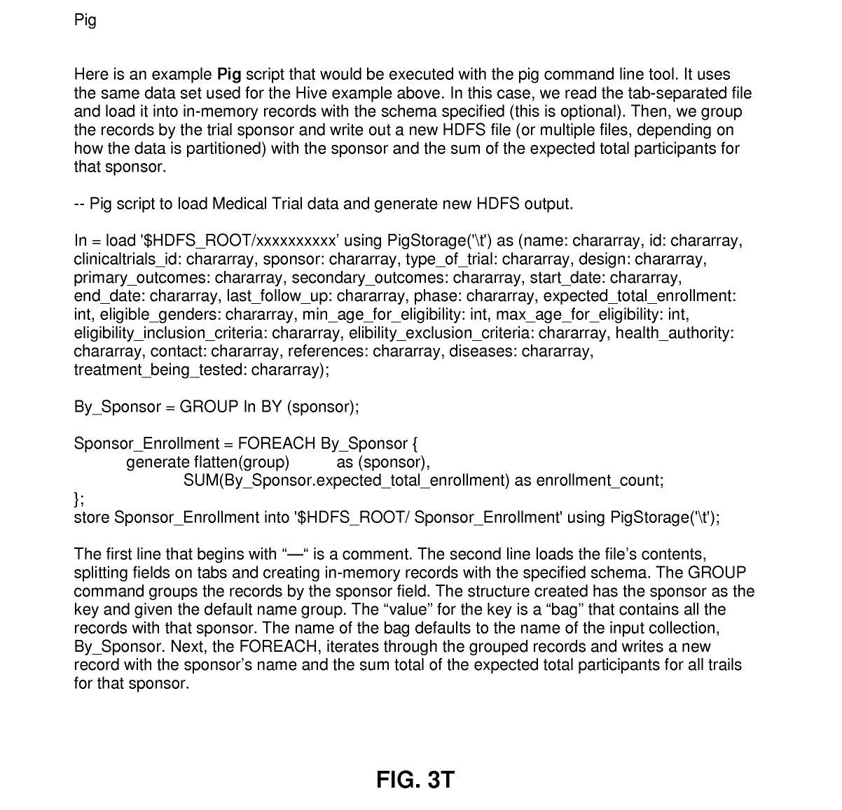

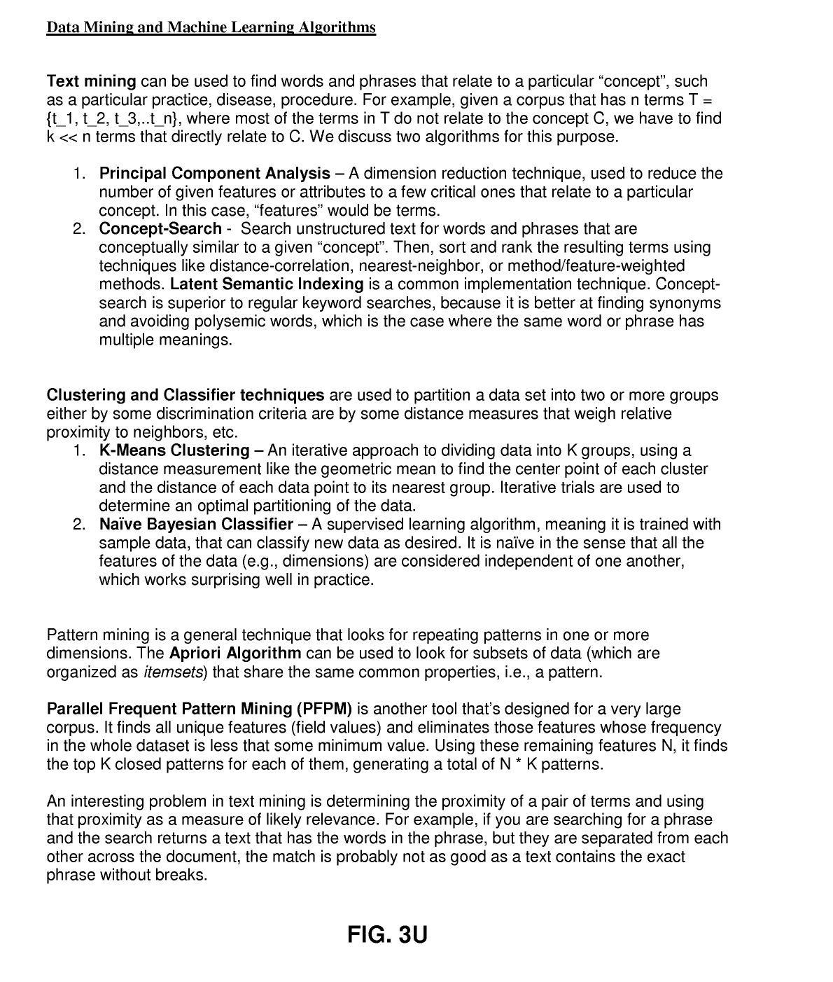

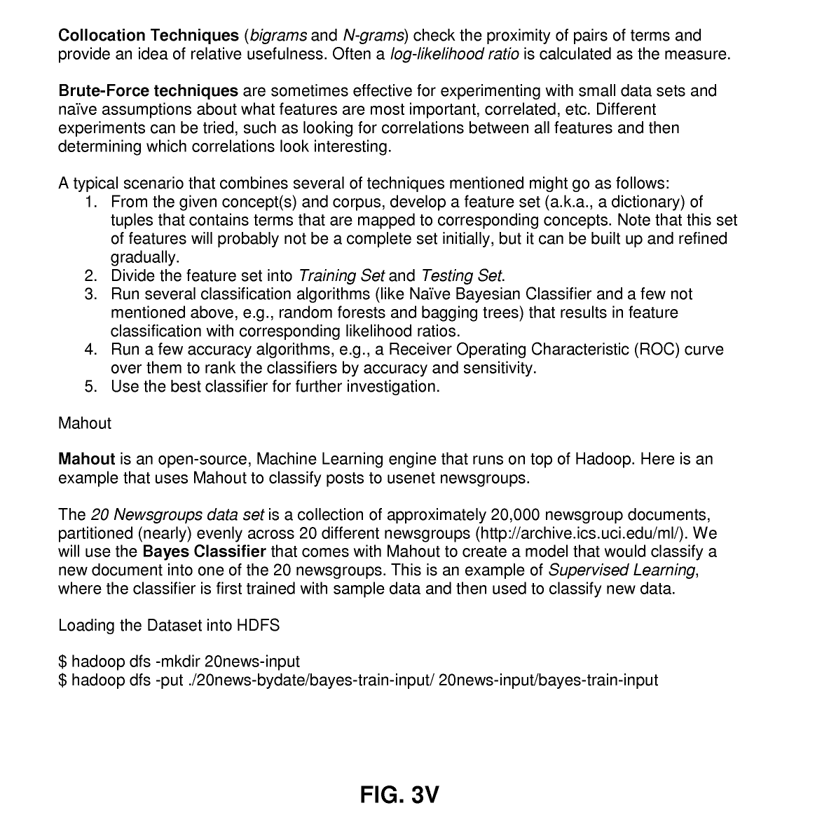

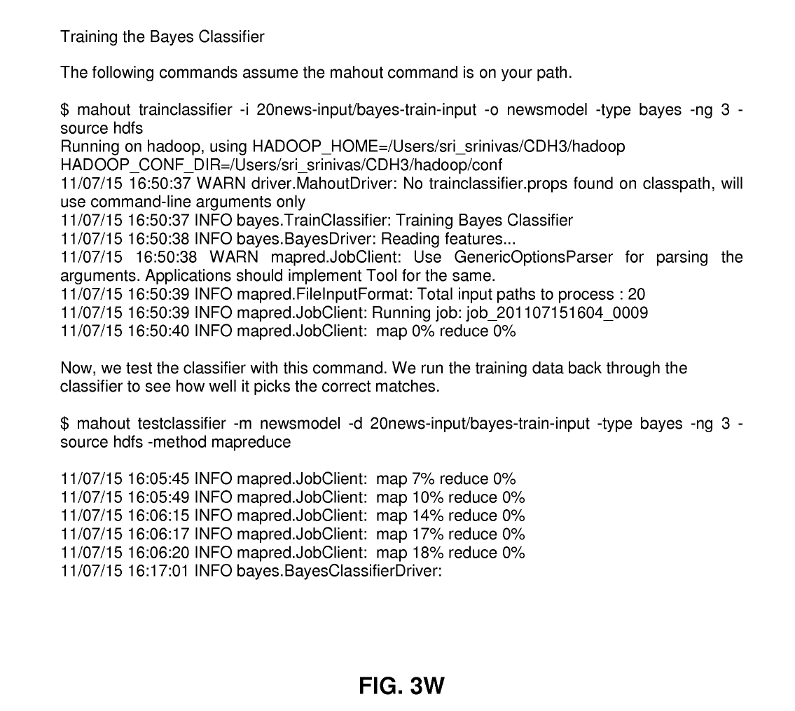

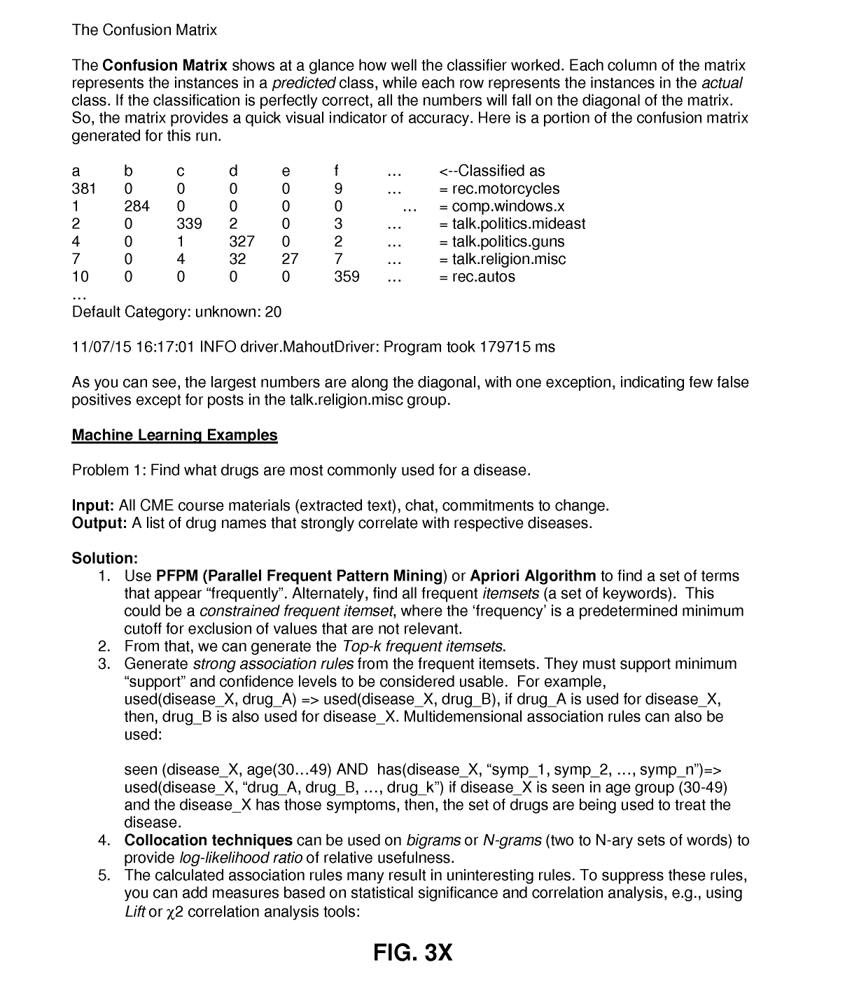

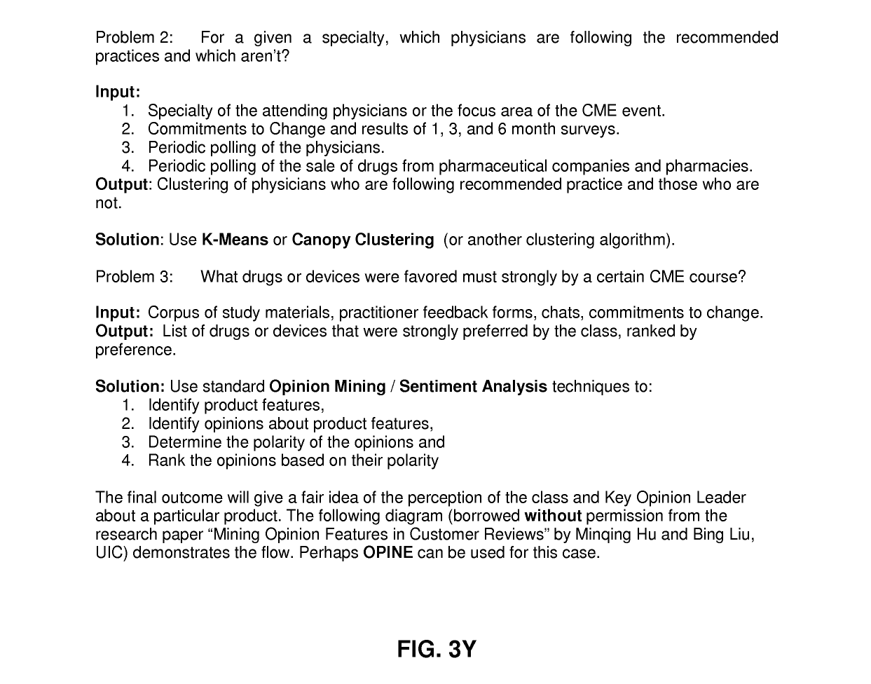

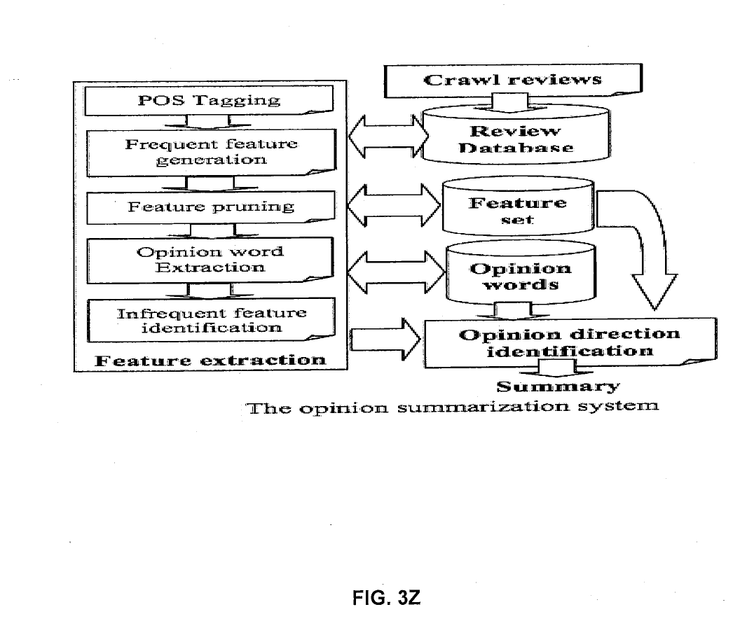

Still referring to FIG. 1, the analytics system 103 may accomplish the transformation and aggregation on the data. More specifically, in data flow 301, the raw data in the Hadoop file system is cleansed and transformed into Hadoop specific tables called HBase tables. The data transformation and aggregation may be accomplished using Pig, which is a tool for defining data flows and transformations that leverage the cluster's reduction framework called MapReduce. Some of the transformations may involve extracting text in formatted documents. The transcripts of audio and video data feeds may also be created and parsed. The resulting tables are designed to be optimal for subsequent analysis. Expanded examples, implementation details, and various screen shots of Sqoop, Hadoop, and Pig, and their use within the analytics system 103 may be found in FIGS. 3A-3T.

According to one aspect, the analytics system 103 may process the data inside the Hadoop distribution file system located in the analytic ecosystem 300 and export the results of analytics in reports, ad-hoc queries, and on-demand reporting 400. In data flow 401, the output of the results from the analytic ecosystem 300 may be accomplished using tools generating standard reporting format 401. The output of the data in a standard reporting format may be accomplished by Hive, a data warehousing infrastructure built on top of Hadoop which provides tools to enable ad hoc querying and data aggregation of large data sets. Additional screen shots, expanded examples, and implementation details of Hive and its use within the analytics system 103 may be found in FIGS. 3A-3T.

The analytics system 103 can also accomplish the output of data resulting from analytics in a format that can be further managed, analyzed and or merged with other data sources by the business intelligence customers. This may be accomplished using tools like Karmasphere or the JasperForge suite. Still referring to FIG. 1, the analytics system 103 may process the data and export the results of advanced data mining and analytics 500. In data flow 501, the data processing and export is accomplished using machine learning techniques. Such advanced data mining techniques may be accomplished using a tool like Mahout, a machine learning library built on top of Hadoop. Machine learning generally refers to allowing the machine to learn through observing data that represents incomplete information about statistical happenings and generalize it to rules and/or algorithms that make predictions for future data, trends, etc. Machine learning typically includes “classification” where machines learn to automatically recognize complex patterns and make intelligent predictions for a class. FIGS. 3U-3Z include expanded examples of machine learning and its various uses within the analytics system 103.

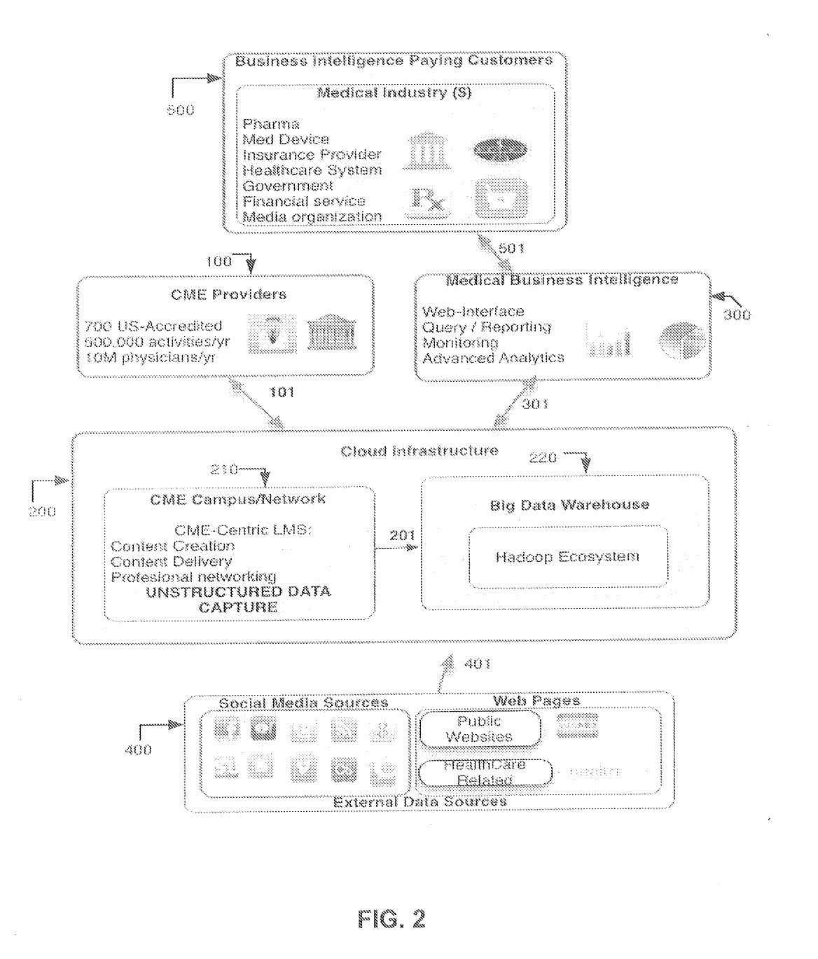

FIG. 2 illustrates an example flowchart for creating predictive business intelligence from unstructured data generated by a professional continuing education event, such as a CME. According to one aspect, CME providers 100 generate unstructured data to be transmitted using a communication link 101 to a CME-centric learning management system 210 hosted in a cloud infrastructure 200. The unstructured data may be captured by a CME-centric LMS 210 within a CME Campus/Network 210 and subsequently transmitted through a communication link 201 to a Big Data Warehouse 220, overlying a non-linear Hadoop based ecosystem analytic engine, which is also hosted within the cloud infrastructure 200. Additional external data sources 400 (e.g., Social Media Sources and Web Pages) may be sent to the Big Data Warehouse 220 for basic and/or comparative analyses, via a communication link 401. The output of the analytics generated by the non-linear Hadoop based ecosystem analytic engine within the Big Data Warehouse 220 is presented as medical business intelligence 300 in one or more accessible formats. The business intelligence paying customers 500 receive the medical business intelligence 300 in one of the accessible formats through a communication link 501.

In the present disclosure, the methods disclosed may be implemented as sets of instructions or software readable and/or executable by a device, such as a processing device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A system for analyzing unstructured data sources generated by a professional continuing education event, the system comprising:
at least one processor;
a memory in operable communication with the at least one processor; and
an analytics system comprising:
a learning management system to:
retrieve unstructured data from one or more professional continuing education events;
a business intelligence application to:
parse the unstructured data;
assign a relevancy value to the unstructured data based on qualitative and quantitative measurements; and
provide the unstructured data based on the relevancy value to a relevant cluster storage location; and
a data warehouse to:
analyze a first set of relevant connections between a sub-set of the unstructured data located within a cluster location; and
analyze a second set of relevant connections between the sub-set of unstructured data located in different cluster location.

2. A method for creating predictive business intelligence from unstructured data comprising:
retrieving, at at least one processor, unstructured data from one or more professional continuing education events;
parsing, at the processor, the unstructured data;
assigning, at the processor, a relevancy value to the unstructured data based on qualitative and quantitative measures;
providing, at the processor, the unstructured data based the relevancy value to a relevant cluster storage location;
analyzing, at the processor, a first set of relevant connections between a sub-set of the unstructured data located within a cluster location; and
analyzing, at the processor, a second set of relevant connections between the sub-set of unstructured data located in different cluster location.
